(19) United States
(12) Patent Application Publication
(10) Pub. No.: US 2005/0225117 A1
(43) Pub. Date: Oct. 13, 2005

(54) Fold-out cargo box for a truck

(76) Inventors: Peter Miskech, Taylor, MI (US); Nate Rolfes, Livonia, MI (US); Jason Lind, Woodhaven, MI (US); Chris Bowser, Dearborn, MI (US); Donald Nakic, Pleasant Ridge, MI (US)

Correspondence Address: Donald Wilkinson;MacMillan Sobanski & Todd, Suite 405, 38705 W. Seven Mile Road, Livonia, MI, 48152, US

(21) Appl. No.: 10/999,680

(22) Filed: Nov. 30, 2004

Related U.S. Application Data
(60) Provisional application No. 60/560,388, filed on Apr. 8, 2004.

(51) Int. Cl. B62D 33/02

(52) U.S. Cl. 296/183.1

(57) ABSTRACT

A cargo box of a truck, such as a pickup truck, may include a horizontal bed having a front, a rear, a first side and a second side, with a transverse oriented front wall extending vertically upward from the front of the bed and having a front top rail located a first height above the bed, a first rear pillar extending upward from the bed adjacent to the rear and the first side of the bed, and a second rear pillar extending upward from the bed adjacent to the rear and the second side of the bed. The cargo box may also include a first side wall, extending between the front wall and the first rear pillar, having a first lower portion fixed to the first side of the bed, and a first fold-out fender located above the first lower portion and pivotable about a first generally horizontal axis between a substantially vertical closed position and a substantially horizontal open position. The cargo box may also include a second side wall, extending along the second side of the bed, that also includes a fixed lower portion and a fold-out fender that is pivotable between a horizontal open position and a vertical closed position. A Tonneau cover may be employed to create a second load floor or shelving.

### CROSS REFERENCE TO RELATED APPLICATIONS

This application claims the benefit of United States provisional patent application identified as Application No. 60/560,388, filed Apr. 8, 2004, which is incorporated herein by reference.

### BACKGROUND OF INVENTION

The present invention relates to cargo boxes on light trucks, such as pickup trucks.

As greater numbers of light trucks, such as pickup trucks, are used for an ever increasing number of work and recreational purposes, the need arises for increased flexibility in storing, transporting and accessing items in the cargo boxes of these trucks. For example, it may be desirable to store some items out of site, protected from the weather, and possibly to lock the items within an enclosed area to deter theft. Accessories such as Tonneau covers and caps may be employed to accomplish this task. But one may wish to also carry larger items that will not fit under the conventional Tonneau covers and caps. In such situations, then, the advantages of these accessories may be somewhat limited. Such large items may even be of a size or shape that they do not readily fit within the typical dimensions of these cargo boxes.

For increased flexibility in carrying items of various sizes and shapes in a cargo box, it may also be desirable to have the capability to vary the size of an enclosed and lockable storage area. Moreover, one may desire the flexibility to have more than one load floor—or optional shelving—so that items do not have to be stacked on top of one another while being transported in the cargo box of the truck. Of course, one may also desire that any additional cargo carrying flexibility be provided in a manner that is relatively simple and quick to use and is aesthetically pleasing. That is, cargo storage devices that are difficult to use or time consuming may be of limited value since they may be seldom deployed. Moreover, if such devices detract significantly from the aesthetically pleasing appearance of the truck, then one may avoid including such a device on the truck at all.

An additional drawback to some cargo boxes and accessories employed therewith is the potential difficulty in accessing items located in the cargo boxes. On a conventional pickup truck, only the tailgate lowers. If one wishes to get at items located more toward the middle or front of the cargo box, one must reach over top rails on the sides or climb in the cargo box. Reaching over the side rails to lift the items out of the cargo box may be particularly difficult for smaller individuals, while climbing in the cargo box may also be undesirable.

Thus, it is desirable to have a cargo box for a light truck, such as, for example, a pickup truck, that provides improved flexibility in storing, transporting and accessing a variety of different items.

### SUMMARY OF INVENTION

In its embodiments, the present invention contemplates a cargo box of a truck. The cargo box may comprise a horizontal bed having a front, a rear, a first side and a second side, and a transverse oriented front wall extending vertically upward from the front of the bed and having a front top rail located a first height above the bed. A first rear pillar may extend upward from the bed adjacent to the rear and the first side of the bed, while a second rear pillar extends upward from the bed adjacent to the rear and the second side of the bed. The cargo box may also include a first side wall, extending between the front wall and the first rear pillar, having a first lower portion extending vertically upward from and being fixed relative to the first side of the bed, and a first fold-out fender located above the first lower portion and pivotable about a first generally horizontal axis that is a second height above the bed, with the second height being less than the first height, and with the first fold-out fender being pivotable between and selectively maintainable in a substantially vertical closed position and a substantially horizontal open position; and a second side wall, spaced from the first side wall, and extending along the second side of the bed.

An advantage of an embodiment of the present invention is that an increased width for supporting cargo wider than a cargo box on a truck is attained. A wider load floor can be created to support the width of the wider load.

Another advantage of an embodiment of the present invention is that multiple height shelves and/or load floors can be created for additional flexibility in storing and transporting cargo.

A further advantage of an embodiment of the present invention is that the access to the cargo box is improved.

An additional advantage of an embodiment of the present invention is that covered storage can be provided while still allowing for additional storage in the cargo box that is above the covered storage area.

### BRIEF DESCRIPTION OF DRAWINGS

FIG. 1 is a rear perspective view of a pickup truck, with a tailgate and fold-out fenders in closed positions and a Tonneau cover removed, in accordance with an embodiment of the present invention.

FIG. 2 is a rear perspective view similar to FIG. 1, but showing the Tonneau cover in its upper box enclosure position.

FIG. 3 is a rear perspective view similar to FIG. 1, but showing the tailgate open and the Tonneau cover in its lower box enclosure position.

FIG. 4 is a is a rear perspective view similar to FIG. 1, but showing the tailgate open and the Tonneau cover in its multiple shelf position.

FIG. 5 is a rear perspective view similar to FIG. 1, but showing the tailgate and fold-out fenders in their open positions.

FIG. 6 is a rear perspective view similar to FIG. 5, but showing the Tonneau cover in its lower box enclosure position.

FIG. 7 is a perspective view of a portion of a fold-out fender in accordance with the present invention.

FIG. 8 is a schematic view of a hinge configuration for a fold-out fender in accordance with a second embodiment of the present invention.

### DETAILED DESCRIPTION

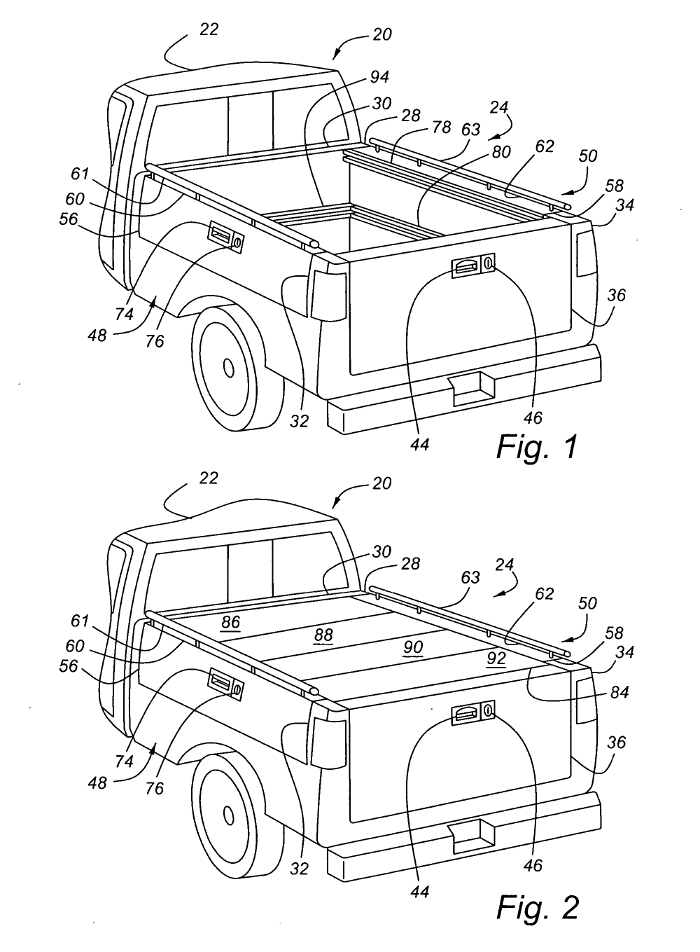

FIGS. 1-7 illustrate a pickup truck, indicated generally at 20, that includes a passenger cab 22 with a cargo box 24 located behind it. The cargo box 24 includes a bed (load floor) 26 defining the bottom horizontal surface thereof. The cargo box 24 also includes a front wall 28 rising vertically upward from and extending transversely across the front 29 of the bed 26. The front wall 28 defines, along its top surface, a front top rail 30 that is a first height H1 above the bed 26.

A first rear pillar 32 extends upward from the bed 26 adjacent to its rear edge 31 and first side 33, and a second rear pillar 34 extends upward from the bed 26 adjacent to its rear edge 31 and second side 35. A tailgate 36 extends between the first and second rear pillars 32, 34 to form the rear of the cargo box 24. The first and second rear pillars 32, 34 and tailgate 36 may extend generally about the same first height H1 above the bed 26 as the front wall 28.

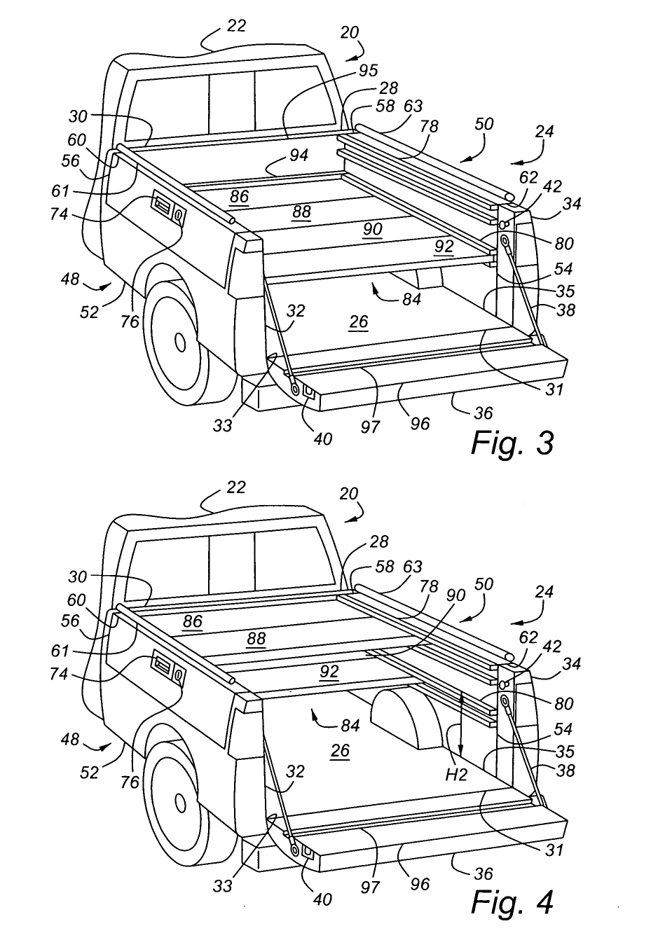

The tailgate 36 may be just a conventional tailgate that is pivotable between a vertical closed position (seen in FIGS. 1 and 2) and a horizontal open position (seen in FIGS. 3-6). A pair of conventional support cables 38 may connect between the first and second rear pillars 32, 34 and respective sides of the tailgate 36 in order to support the tailgate 36 in its open position. Conventional latches 40 may be included on each side of the tailgate 36 and mate with conventional striker pins 42, extending from the first and second rear pillars 32, 34, in order to hold the tailgate 36 in its closed position. A conventional release handle and mechanism 44, then, may operatively engage the latches 40, allowing one to release the tailgate 36 from its closed position. The release handle and mechanism 44 may include a conventional lock 46 for selectively preventing the release handle from releasing the tailgate 36 from its closed position. The release handle and mechanism 44, latches 40, and lock 46 will not be described in any more detail herein since they are known to those skilled in the art.

The cargo box 24 also includes a first side wall 48 that extends longitudinally—along the first side 33 of the bed 26—between the front wall 28 and the first rear pillar 32, and a second side wall 50 that extends longitudinally—along the second side 35 of the bed 26—between the front wall 28 and the second rear pillar 34. The first side wall 48 includes a first lower portion 52 extending vertically upward from and fixed relative to the first side 33 of the bed 26, and the second side wall 50 includes a second lower portion 54 extending vertically upward from and fixed relative to the second side 35 of the bed 26. Both of the lower portions 52, 54 extend upward to a height of about H2. This height H2 is less than the height H1. The difference in height on the first side is accounted for by a first fold-out fender 56, mounted above the first lower portion 52 and extending upward to define a first side top rail 60 along its upper surface. The first side top rail 60, then, is at approximately the height H1 above the bed 26 when the first fold-out fender 56 is in its vertical closed position. The difference in height on the second side is accounted for by a second fold-out fender 58, mounted above the second lower portion 54 and extending upward to define a second side top rail 62 along its upper surface. The second side top rail 62 is at approximately the height H1 above the bed 26 when the second fold-out fender 58 is in its vertical closed position.

Optionally, the first fold-out fender 56 may include a hand railing 61 mounted above the first side top rail 60 and the second fold-out fender 58 may include a hand railing 63 mounted above the second side top rail 62. These railings 61, 63 may be used for various purposes, such as providing tie-down locations for straps or providing a handy place for one to grip when opening or closing the fold-out fenders 56, 58.

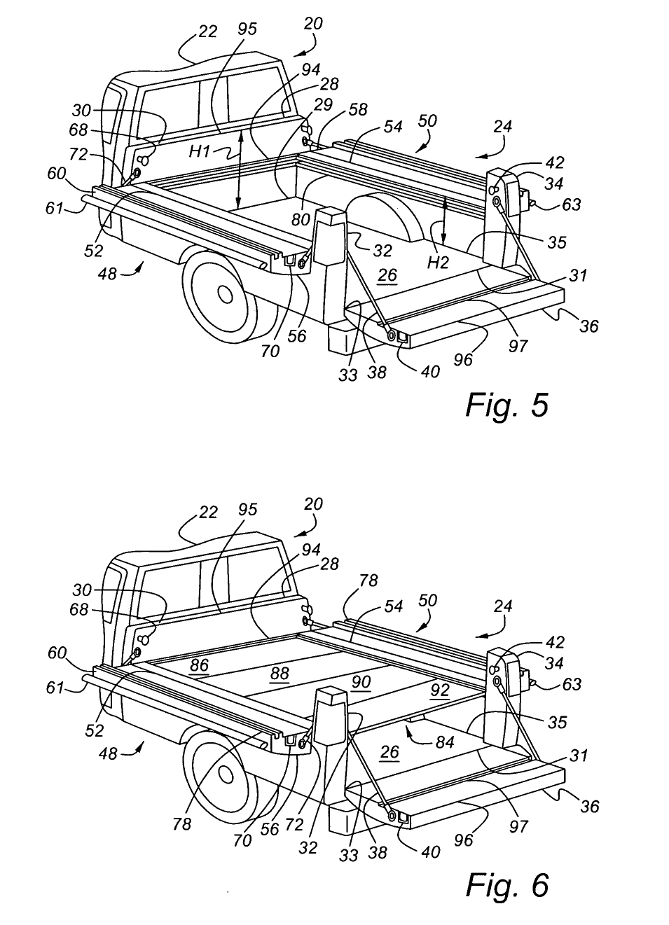

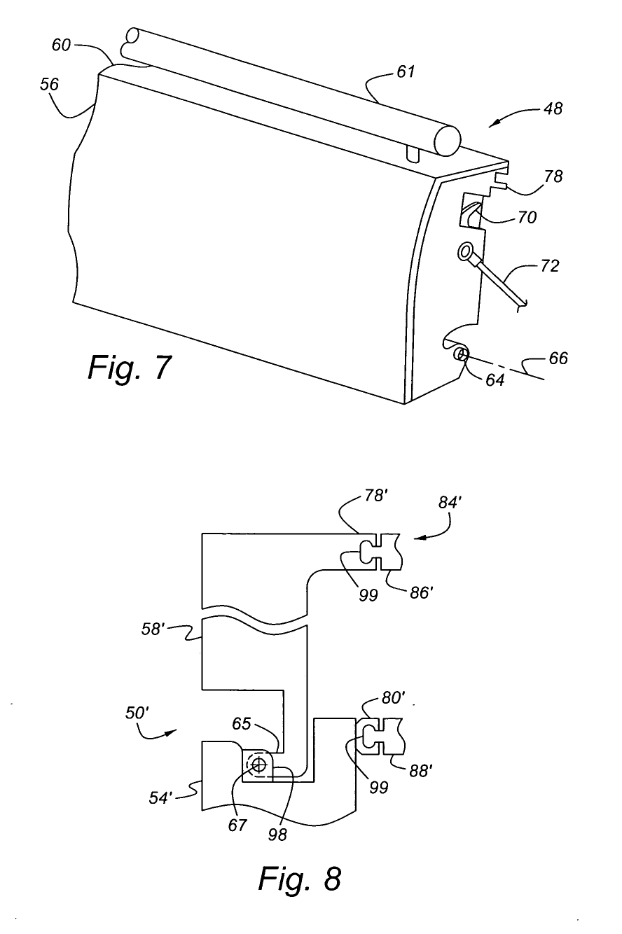

The first fold-out fender 56 pivotally connects, via hinges 64 (one shown in FIG. 7), between the front wall 28 and the first rear pillar 32, for pivoting movement about a horizontal pivot axis 66 between a vertical closed position (shown in FIGS. 1-4) and a horizontal open position (shown in FIGS. 5 and 6). The hinges 64 may be similar to the conventional hinges employed with the tailgate 36. As an alternative, the first lower portion 52 may have a small section (not shown) adjacent to the front wall 28 that extends upward to the height of the top rails. The first fold-out fender 56, then, may pivotally connect to this small section via a hinge rather than directly to the front wall 28.

In order to hold the first fold-out fender 56 in its closed position, the front wall 28 and first rear pillar 32 may include striker pins 68, with the first fold-out fender 56 including corresponding latches 70. A release handle and mechanism 74, then, may operatively engage the latches 70, allowing one to release the first fold-out fender 56 from its closed position. The release handle and mechanism 74 may include a lock 76 for selectively preventing the release handle from releasing the first fold-out fender 56 from its closed position. A pair of support cables 72 may include one that connects between the front wall 28 and a forward side of the first fold-out fender 56 and another that connects between the first rear pillar 32 and a rearward side of the first fold-out fender 56 in order to support the fold-out fender 56 when in its horizontal open position. The release handle and mechanism 74, latches 70, lock 76, and support cables 72 may be very similar to the mechanisms employed with conventional tailgates. Employing such conventional components may reduce costs for these components. Moreover, for convenience in operation, the lock 76 on the first fold-out fender 56 may be keyed the same as the tailgate lock 46. Or, if not desired, the locks may be eliminated. In addition, the release handle and mechanism 74 may be located at positions other than that shown in the figures, if desirable for reasons of aesthetics or convenience.

Even though, for some features of the cargo box 24, only the feature on the left or right side is shown, the cargo box 24 is generally symmetrical right to left, so the opposite side is just the mirror image of the feature shown on that first side. Accordingly, for the description herein, if the feature is shown on only a first side, the feature on the second, opposite side is presumed to be the mirror image of the feature shown on the first side. Accordingly, hinges, latching, and support mechanisms just discussed relative to the first fold-out fender 56 may also be employed in the same fashion with the second fold-out fender 58.

The various components of the cargo box 24 may be made of, for example, sheet molding compound, steel, aluminum, a combination of these materials, or other suitable materials known to those skilled in the art. The particular materials selected to employ on a particular vehicle may depend upon cost, weight, ease of fabrication, or other typical factors.

With these fold-out fenders 56, 58, one may leave both of them in the vertical closed positions, which results in a cargo box 24 having similar dimensions to a conventional cargo box, (shown in FIG. 1). Or, when needed, one may deploy one or both of the fold-out fenders 56, 58 to their horizontal open positions (shown in FIG. 5) in order to expand the overall width of the cargo box 24.

The first and second side walls 48, 50 may include additional features that further increase the versatility of the cargo box 24 when storing and transporting various items. A pair of upper cover supports 78 may longitudinally extend along the inside surface of the first and second fold-out fenders 56, 58 just below the first and second side top rails 60, 62. These supports 78 may be in the form of C-shaped channels. A pair of lower cover supports 80 may longitudinally extend along the inside surfaces 53, 55 of the first and second lower portions 50, 52, respectively, near the upper edges of these lower portions 50, 52. Again, these cover supports 80 may be in the form of C-shaped channels. Although, other shapes, as well as other types of supports or bracketry may be employed for the upper and lower cover supports 78, 80, if so desired.

A Tonneau cover 84 may be employed to add flexibility in configuring the cargo box 24 for a particular use. The Tonneau cover 84 may be made up of four separate panels 86, 88, 90, 92, with each panel 86, 88, 90, 92 extending across the width of the cargo box 24 and slidable into the corresponding upper or lower cover supports 78, 80. The four panels 86, 88, 90, 92 may be all mounted in the upper cover supports 78, thus being employed as a more conventional type of Tonneau cover 84 (shown in FIG. 2). These panels 86, 88, 90, 92 may be formed sturdy enough to support loads on their upper surfaces, allowing for their use as a second load floor (shown in FIGS. 3 and 6) or shelves (shown in FIG. 4). The panels 86, 88, 90, 92 may also be light weight for ease in sliding them in and out from the upper and lower cover supports 78, 80. In particular, FIG. 6 shows how the Tonneau cover 84 may be employed with the fold-out fenders 56, 58 in their open horizontal positions to create both an enclosable, lockable cargo area under the cover 84 with an extra wide second load floor for carrying items that are wider than the cargo box 24.

While four panels 86, 88, 90, 92 are shown making up the Tonneau cover 84, other numbers of panels may be employed. The number and lengths may depend upon the length of the particular cargo box 24, which may be, for example, a standard eight feet or five and one half feet long. Moreover, the panels 86, 88, 90, 92 need not all be the same length. And, of course, the width of the panels 86, 88, 90, 92 can be matched to the particular width of the cargo box 24, regardless of whether it is a compact, full size or heavy duty pickup truck 20.

The front wall 28 of the cargo box 24 may include a sealing feature 94 extending across its rear surface 95 that allows the first panel 86 of the Tonneau cover 84 to seal against the front wall 28. Also, the front surface 96 of the tailgate 36 may have a sealing feature 97 that allows the fourth panel 92 of the Tonneau cover 84 to seal against the tailgate 36. Accordingly, when the four panels 86, 88, 90, 92 are all mounted in the lower cover supports 80 to form a second load floor with an enclosed cargo area underneath, this enclosed cargo area may be protected from the weather, including snow and rain, while the cargo area above the Tonneau cover 84 is still open to provide for transportation of oversized items.

FIG. 8 illustrates a second embodiment of the present invention. In this embodiment, the hinge assemblies for the fold-out fenders, supports for holding the fold-out fenders in the horizontal open position, as well as the cover supports are modified. For purposes of this description, elements in this embodiment that have counterpart elements in the first embodiment are identified by similar reference numerals, but with an added prime.

The second lower portion 54′ of the second side wall 50′ includes hinge brackets 98 (only one shown) spaced therealong, with each of the hinge brackets 98 engaging hinges 65 (only one shown) on the second fold-out fender 58′ about a second horizontal pivot axis 67. By spacing hinge locations along the length of a fold-out fender, one may be able to better support longer fold-out fenders than the more conventional tailgate types of hinges employed in the first embodiment. Moreover, while the hinges 65 are configured to be hidden hinges, other types of hinge configurations, including exposed hinges, may be employed instead, if so desired.

In this second embodiment, the second fold-out fender 58′ and the second lower portion 54′ are shaped so that a portion of the second fold-out fender 58′ comes to rest on a portion of the second lower portion 54′ when the second fold-out fender 58′ reaches its horizontal open position. This may eliminate the need for support cables (not shown in FIG. 8), if so desired.

The second embodiment also shows upper cover supports 78′ and lower cover supports 80′ with modified cross sectional shapes. The panel sections 86′, 88′ (only two shown in FIG. 8) of the Tonneau cover 84′ include mounting features 99 extending along their sides that match the modified cross sectional shapes of the cover supports 78′, 80′. Of course, other shapes and types of cover supports may be employed to mount the Tonneau cover panels, if so desired.

While certain example embodiments of the present invention have been described in detail, those familiar with the art to which this invention relates will recognize various alternative designs and embodiments for practicing the invention as defined by the following claims.

1. A cargo box of a truck comprising;
a horizontal bed having a front, a rear, a first side and a second side;
a transverse oriented front wall extending vertically upward from the front of the bed and having a front top rail located a first height above the bed;
a first rear pillar extending upward from the bed adjacent to the rear and the first side of the bed;
a first side wall, extending between the front wall and the first rear pillar, having a first lower portion extending vertically upward from and being fixed relative to the first side of the bed, and a first fold-out fender located above the first lower portion and pivotable about a first generally horizontal axis that is a second height above the bed, with the second height being less than the first height, and with the first fold-out fender being pivotable between and selectively maintainable in a substantially vertical closed position and a substantially horizontal open position; and
a second side wall, spaced from the first side wall, and extending along the second side of the bed.

2. The cargo box of claim 1 further including a second rear pillar extending upward from the bed adjacent to the rear and the second side of the bed, and wherein the second side wall has a second lower portion extending vertically upward from and being fixed relative to the second side of the bed, and a second fold-out fender located above the second lower portion and pivotable about a second generally horizontal axis that is the second height above the bed, with the second fold-out fender being pivotable between and selectively maintainable in a substantially vertical closed position and a substantially horizontal open position.

3. The cargo box of claim 2 wherein the first lower portion has a first inner surface that faces the second side wall and includes a first horizontally disposed cover support extending along the first inner surface, and the second lower portion has a second inner surface that faces the first side wall and includes a second horizontally disposed cover support extending along the second inner surface, with the first and second cover supports defining a generally horizontally extending plane spaced a third height above the bed that is less than the first height.

4. The cargo box of claim 3 further including a cover extending between and selectively removable from the first and second horizontally disposed cover supports.

5. The cargo box of claim 4 wherein said cover is comprised of a plurality of separate cover panels that each extend between the first and second cover supports.

6. The cargo box of claim 3 further including a first upper horizontally disposed cover support extending along the first fold-out fender and a second upper horizontally disposed cover support extending along the second fold-out fender and, when the first and second fold-out fenders are in their respective closed vertical positions, the first and second upper horizontally disposed cover supports define a horizontal plane spaced above the bed a fourth height that is greater than the third height.

7. The cargo box of claim 1 further including a tailgate pivotally connected between the first rear pillar and the second side wall adjacent to the rear of the bed and pivotable between a vertical closed position and a horizontal open position, with the tailgate including a latch assembly for selectively releasing the tailgate from the vertical closed position and a lock assembly for selectively preventing the latch assembly from releasing the tailgate.

8. The cargo box of claim 7 wherein the first fold-out fender includes a latching assembly for selectively releasing the first fold-out fender from the substantially vertical closed position and a locking assembly for selectively preventing the latching assembly from releasing the first fold-out fender.

9. The cargo box of claim 1 wherein the first fold-out fender includes a latching assembly for selectively releasing the first fold-out fender from the substantially vertical closed position and a locking assembly for selectively preventing the latching assembly from releasing the first fold-out fender.

10. The cargo box of claim 1 further including a hand railing mounted on and extending along the first fold-out fender.

11. The cargo box of claim 1 further including a tailgate pivotally connected between the first rear pillar and the second side wall adjacent to the rear of the bed and pivotable between a vertical closed position and a horizontal open position, with the tailgate including a front surface and a horizontally disposed cover sealing feature on the front surface.

12. The cargo box of claim 1 wherein the front wall has a rear surface and horizontally disposed cover sealing feature on the rear surface.

13. The cargo box of claim 1 wherein the cargo box is on a pickup truck.

14. The cargo box of claim 1 wherein the first fold-out fender is hingedly attached to the first lower portion for the pivotal movement between the vertical closed position and the horizontal open position.

15. The cargo box of claim 1 wherein the first fold-out fender is hingedly attached to the front wall and the first rear pillar for the pivotal movement between the vertical closed position and the horizontal open position.

16. The cargo box of claim 1 wherein the first lower portion includes a support to maintain the first fold-out fender in its horizontal open position.

17. The cargo box of claim 1 wherein the first fold-out fender extends from the front wall to the first rear pillar.

18. The cargo box of claim 1 wherein the first fold-out fender has an upper surface that defines a side top rail that is at the first height above the bed when the first fold-out fender is in the vertical closed position.

19. A cargo box of a pickup truck comprising;
a horizontal bed having a front, a rear, a first side and a second side;
a transverse oriented front wall extending vertically upward from the front of the bed and having a front top rail located a first height above the bed;
a first rear pillar extending upward from the bed adjacent to the rear and the first side of the bed;
a second rear pillar extending upward from the bed adjacent to the rear and the second side of the bed;
a first side wall, extending between the front wall and the first rear pillar, having a first lower portion extending vertically upward from and being fixed relative to the first side of the bed, and a first fold-out fender located above the first lower portion and pivotable about a first generally horizontal axis that is a second height above the bed, with the second height being less than the first height, and with the first fold-out fender being pivotable between and selectively maintainable in a substantially vertical closed position and a substantially horizontal open position, and with the first fold-out fender including a first latching assembly for selectively releasing the first fold-out fender from the substantially vertical closed position and a first locking assembly for selectively preventing the first latching assembly from releasing the first fold-out fender; and
a second side wall, extending between the front wall and the second rear pillar, having a second lower portion extending vertically upward from and being fixed relative to the second side of the bed, and a second fold-out fender located above the second lower portion and pivotable about a second generally horizontal axis that is the second height above the bed, with the second fold-out fender being pivotable between and selectively maintainable in a substantially vertical closed position and a substantially horizontal open position, and with the second fold-out fender including a second latching assembly for selectively releasing the second fold-out fender from the substantially vertical closed position and a second locking assembly for selectively preventing the second latching assembly from releasing the second fold-out fender.

20. A cargo box of a pickup truck comprising;
a horizontal bed having a front, a rear, a first side and a second side;
a transverse oriented front wall extending vertically upward from the front of the bed and having a front top rail located a first height above the bed;
a first rear pillar extending upward from the bed adjacent to the rear and the first side of the bed;
a first side wall, extending between the front wall and the first rear pillar, having a first lower portion extending vertically upward from and being fixed relative to the first side of the bed, and a first fold-out fender located above the first lower portion and pivotable about a first generally horizontal axis that is a second height above the bed, with the second height being less than the first height, and with the first fold-out fender being pivotable between and selectively maintainable in a substantially vertical closed position and a substantially horizontal open position, and with the first lower portion having a first inner surface that includes a first horizontally disposed cover support extending therealong;
a second side wall, spaced from the first side wall, and extending along the second side of the bed, and having a second inner surface that includes a second horizontally disposed cover support, with the first and second cover supports defining a generally horizontally extending plane spaced a third height above the bed that is less than the first height; and
a cover extending between and selectively removable from the first and second horizontally disposed cover supports.
